(19) United States
(12) Patent Application Publication
(10) Pub. No.: US 2016/0165836 A1
(43) Pub. Date: Jun. 16, 2016

(54) Recirculating Pet Fountain with Pet Food Holder

(71) Applicant: PIONEER PET PRODUCTS, LLC, Cedarburg, WI (US)

(72) Inventor: John M. Lipscomb, Cedarburg, WI (US)

(21) Appl. No.: 14/906,762

(22) PCT Filed: Jul. 24, 2014
(86) PCT No.: PCT/US2014/048091

§ 371 Date: Jan. 21, 2016

Related U.S. Application Data
(60) Provisional application No. 61/858,112, filed on Jul. 24, 2013.

(51) Int. Cl. A01K 5/00; A01K 7/00

(52) U.S. Cl. CPC A01K 5/00; A01K 7/00

(57) ABSTRACT

A recirculating pet fountain includes a pet food holder receiving pet food providing material that can be a growable pet food that provides food edible by a pet using the fountain. The holder receives water from the fountain at least wetting and preferably watering growable pet food causing germination or growth that produces pet edible food. During fountain operation, some water recirculated by the pump is diverted to the food holder. The holder can be a pocket formed in the fountain cover or basin in water flow communication with filtered water discharged from the pump. The holder can include a drain so excess water can be returned and can have a cap substantially covering the holder, including when not in use. Growable pet food in the holder, such as seeds, buds, roots, shoots, sprouts, plants, and the like can germinate and grow when nourished with water provided to the holder.

### FIELD

The present invention relates generally to a pet watering device and more particularly to a recirculating pet fountain configured with a pet food holder that preferably is an integral grower for growing a growable pet food using water recirculated through the fountain during fountain operation. Such a pet fountain is particularly well suited for use as a waterer or watering device for an animal, such as a cat or dog and to provide food to the animal grown using water recirculating in the fountain.

### BACKGROUND

While animal and pet watering devices have enjoyed considerable commercial success, improvements nonetheless remain desirable. For instance, a watering device that additionally provides pet food would allow a pet to both eat and drink at the same watering device. Additionally, many animals prefer raw or living food as opposed to dried or preserved food. Most raw or living food is planted into raised planters that can easily be knocked over or are toppled when accessed by the pet. Yet another issue is that pets often overeat when a surplus of living food is available, which can be unhealthy for the pet and can kill the living food.

What is needed is an improved recirculating pet fountain that provides living food material and addresses one or more of the above issues.

### SUMMARY

The present invention is directed to a recirculating pet fountain that includes a water-holding fountain basin having a sidewall, a pump in water-flow communication with the basin, and a pet food holder that holds pet food providing material that provides pet edible food that a pet can eat while at the pet fountain. A recirculating pet fountain constructed in accordance with the present invention preferably includes a filter upstream of the pump and a fountain cover with the pet food holder carried by either the cover or the basin. The pet food holder is wetted by water recirculating through the fountain by the pump that wets pet food providing material in the holder that helps produce pet edible food from the pet food providing material. In a preferred fountain embodiment, water discharged from the pump recirculates through the fountain with some of the water discharged from the pump provided to the pet food holder to enable pet food providing material in the holder to be wetted if not watered by the water.

The pet food holder preferably is a recess formed in either the fountain cover or the fountain basin that defines a pocket that is a grower pocket where the pet food providing material received in the holder is a growable pet food. In a preferred fountain embodiment, the pet food holder is a recess integrally formed in the fountain cover that defines an integrally formed pocket in which the pet food providing material is received that is an integrally formed grower pocket where the pet food providing material is a growable pet food. The pet food providing material preferably is removably or releasably received in the pocket enabling the pet food providing material to be removed and replaced if desired or needed. The pet food holder, including its pocket, preferably is easily accessible to not only facilitate removal and replacement of pet food providing material but also to enable the pocket to be cleaned, such as in a dishwasher or the like.

A preferred pet food holder receives water discharged from the pump during fountain operation that wets pet food providing material received in the holder.

As indicated, the pet food holder is configured to receive a pet food providing material. The pet food providing material received in the pet food holder is at least wetted by water from the fountain that helps the pet food providing material form pet edible food, produce more pet edible food, grow into pet edible food, and/or grow additional pet edible food. The pet food providing material received in the pet food holder can and preferably does include a growable pet food provided in a form that can grow when wetted by water to either grow pet edible food and/or to grow more pet edible food. For instance, the growable pet food can be originally provided in the form of one or more of seeds, sprouts, or plants that can be pet edible in the form as originally provided, but which preferably grows or further grows when wetted with water from the fountain to provide pet edible food and/or produce more pet edible food. When the growable pet food is wetted with water from the fountain, the pet edible food that grows is accessible by a pet using the fountain in a manner that enables the pet to eat the pet edible food. Where the pet food providing material is or includes growable pet food, its growth over time provides enough pet edible food over time to enable a pet to repeatedly consume it at least a plurality of pairs, i.e., at least three, times, as it continues to grow.

If desired, a growing medium may be received in the pet food holder to help facilitate or otherwise further support growth of the growable pet food including by fertilizing the growable pet food, treating the growable pet food, making it edible or more edible, and/or otherwise enhancing the growable pet food. Where a growing medium is used, the growable pet food can be impregnated in the growing medium, inserted into the growing medium, or otherwise carried by the growing medium. Where a growing medium is used, the growing medium and growable pet food can be packaged together as a unit that can be inserted as a unit into the pet food holder when it is desired to produce pet edible food therefrom. Where packaged together as a unit, such units can be sold or otherwise provided separately from the fountain enabling a user of the fountain to repeatedly replenish the pet food holder of a fountain where the growable pet food has been consumed or otherwise spent. This also enables different units having different types of growable pet food to be made and sold for such a pet fountain equipped with such a pet food holder constructed in accordance with the present invention.

Where a growing medium is used, one preferred growing medium is in the form of a porous foam insert that is disposed in the pet food holder. Where such a porous foam insert growing medium is used, the growable pet food would then be located within the porous foam insert.

Water in the fountain is provided to the pet food holder of the fountain wetting at least some of the pet food providing material received in the holder. During recirculating pet fountain operation, some of the water recirculating through the fountain is used to wet pet food providing material received in the holder. During operation, the pump recirculates water in the fountain with at least some of the water recirculated by the pump reaching the pet food holder and wetting pet food providing material received in the holder. In a preferred embodiment, at least some of the water discharged from the pump is directed to the pet food holder with more of the water discharged from the pump recirculating through the rest of the fountain.

If desired, a continuous flow of water can be provided to the pet food holder during recirculating pet fountain operation with some of the water provided to the holder not used or not needed by the holder being returned to be recirculated. In one preferred embodiment, water discharged from the pump continuously flows to the holder with excess water that is not used or not needed returned to be pumped by the pump again. In one such preferred embodiment, some of the water discharged from the pump is recirculated through the pet food holder with excess water being returned to the basin where it can be pumped again by the pump. In such a preferred embodiment, a first flow of water discharged from the pump recirculates through the fountain and a second flow of water discharged from the pump recirculates through the pet food holder with water being returned in both instances to the basin. The first recirculating flow of water discharged by the pump that recirculates through the fountain preferably has a flow rate substantially greater than the second recirculating flow of water discharged by the pump that recirculates through the pet food holder. In one preferred embodiment, the first recirculating flow of water has a flow rate at least twice as great as the flow rate of the second recirculating flow of water. In another preferred embodiment, the first recirculating flow of water has a flow rate at least four times as great as the flow rate of the second recirculating flow of water.

Where water discharged from the pump is used to wet pet food providing material received in the pet food holder, the water preferably is filtered first. In a preferred embodiment, water entering the pump is first drawn through the filter thereby filtering the water right before the water is discharged from the pump with at least some of the discharged filtered water being directed to the pet food holder instead of the basin. Where pet food providing material in the pet food holder is or includes growable pet food, water directed to the holder is freshly filtered before reaching the holder so that the growable pet food is watered with freshly filtered water.

Where the fountain has a cover that includes a spillway down which water flows into the fountain basin, water being recirculated by the pump is drawn from the basin through the filter before being discharged from the pump to the cover where the water flows down the spillway back into the basin with some of the discharged filtered water provided to the pet food holder instead of or before reaching the basin. In such a preferred embodiment, the pump has a discharge outlet from which water discharged from the pump wets the pet food providing material located in the pet food holder. Where the pet food providing material is or includes a growable pet food, wetting of the growable pet food preferably nourishes and/or waters the growable pet food which results in growth of the growable pet food providing self-replenishing pet edible food.

The water can be pumped directly from the pump discharge to the pet food holder. Where this is the case, water pumped from the pump can be directed or diverted downstream of the pump discharge to the pet food holder through a water conveying conduit, such as a tube, which can extend from at or adjacent the pump discharge to the holder. A portion of the water from the pump discharge preferably is recirculated through the pet fountain and another portion of the water from the pump discharge is directed to the pet food holder preferably through such a water conveying conduit.

Where the fountain has a cover, such a water conveying conduit can underlie the cover producing a recirculating pet fountain equipped with a pet food holder constructed in accordance with the present invention that allows a substantially continuous flow of water to flow from the cover back into the basin at substantially the same time as water is being delivered to the pet food holder. In one such cover-equipped fountain embodiment, operation of the pump can provide a first substantially continuous flow of water to the cover that preferably flows from the cover back into the basin and a second substantially continuous flow of water that flows through the water conveying conduit to the pet food holder. If desired, the water conveying conduit can be integrally formed with either the cover or the base of the fountain with the water conveying conduit preferably integrally formed with the cover where the fountain is equipped with a cover.

Where the fountain has a cover equipped with a spillway, such a water conveying conduit can underlie the spillway of the cover with fountain operation causing a substantially continuous flow of water flowing down the spillway of the cover at substantially the same time that water is being delivered to the pet food holder. In one such spillway-equipped fountain embodiment, operation of the pump can provide a first substantially continuous flow of water that flows down the spillway back into the basin and a second substantially continuous flow of water that flows through the water conveying conduit to the pet food holder.

In one preferred embodiment, the pump discharge outlet can be in water flow communication with both the fountain cover and the pet food holder. For instance, water can be delivered to the cover from the pump through a lift tube. The lift tube can be integrally formed into the cover. The lift tube cab also telescopically register with the discharge outlet of the pump. This helps to align the cover with the basin. Such a fountain preferably includes such a water conveying conduit that can extend from the pump discharge outlet and/or the lift tube to the pet food holder. Further still, the lift tube may have a flow diverter, from which the water conveying conduit can extend with the flow diverter diverting some of the water discharged from the pump into the water conveying conduit and to the pet food holder. Such a water conveying conduit can include an elongate tube that connects the lift tube to the pet food holder and can be integrally formed with the lift tube if desired.

A drain may be located in the pet food holder from which excess water in the pet food holder that is not needed or not used drains from the pet food holder so the excess water can return to the pump. Where the fountain has a cover equipped with a pet food holder, the drain in the holder preferably returns excess water in the pet food holder to the basin where the water can be drawn by the pump through the filter to be recirculated by the pump. Particularly where the pet food holder is part of the cover, the pet food holder can overlie and be spaced above water received in the basin. In such a configuration, the water is then recirculated by the pump from the basin to the cover and pet food holder and back to the basin.

In another embodiment, the recirculating pet fountain can include a water-holding fountain basin, a fountain cover carried by the basin, and a pump having an intake in water-flow communication with the fountain basin and a discharge outlet in water-flow communication with the fountain cover. A pet food holder is carried by either the fountain basin or the fountain cover and the pet food holder is in water-flow communication with the pump. The discharge outlet of the pump provides water to the fountain cover during pump operation with a portion of the water recirculating from the fountain cover to the basin and another portion of water going to the pet food holder. The pet food holder may also have a drain through which water may be returned to the water in the basin during recirculating fountain operation. The pet food holder receives growable pet food in the form of a plurality of seeds, seedlings, sprouts, or plants that can be nourished by water delivered from the pump to grow and provide self-replenishing pet edible food. The excess water is then returned by the drain to the basin.

The cover may additionally have a lift tube that can couple to the pump. The lift tube may have a flow diverter in communication with a water conveying conduit that diverts less than all of the water discharged from the pump to the pet food holder. If desired, water conveying conduit may be provided in the form of a flow-diverting water conveying conduit that is in water flow communication with the pump and the pet food holder and which is integrally formed with the flow diverter.

In yet another embodiment, the recirculating pet fountain includes a water-holding fountain basin, a fountain cover that is carried by the basin and a pump with an intake that is in water-flow communication with the fountain basin and a discharge outlet in water-flow communication with the fountain cover. The cover has a pet food holder that is or includes an integrally formed grower pocket with an opening formed in an outer surface of the cover. The pump recirculates water from the cover to the basin while delivering water to the grower pocket of the holder that enables seeds, seedlings, sprouts, or plants to consume water delivered by the grower pocket. The pocket may further include a drain through which excess water in the grower pocket flows into the basin. A removable cap can be provided that overlies the opening of the grower pocket and which can be received in the opening to substantially cover the pocket. The cap can seat in a manner that allows growable pet food to grow upwardly from the pocket around the cap producing self-replenishing pet edible food extending exteriorly from the fountain that a pet using the fountain can eat.

### BRIEF DESCRIPTION OF THE DRAWINGS

One or more preferred exemplary embodiments of the invention are illustrated in the accompanying drawings in which like reference numerals represent like parts throughout and in which:

FIG. 1 is a top front perspective view of a preferred embodiment of a recirculating pet fountain having a pet food holder constructed in accordance with the present invention configured as an integral grower for growing pet edible food watered using water from the fountain;

FIG. 2 is an enlarged fragmentary top rear perspective view of the recirculating pet fountain and pet food holder of FIG. 1;

FIG. 3 is a longitudinal cross section elevation view of the recirculating pet fountain and pet food holder of FIG. 1;

FIG. 4 is an enlarged fragmentary top rear perspective view of the fountain basin of FIG. 2 with the cover of the recirculating pet fountain shown in phantom for clarity;

FIG. 5 is a top perspective view of the fountain cover removed from the basin;

FIG. 6 is a bottom perspective view of the cover of FIG. 5;

FIG. 7 is an enlarged fragmentary perspective view of part of the underside of the cover shown in FIG. 6;

FIG. 8 is an exploded perspective view of the recirculating pet fountain and pet food holder of FIG. 1;

FIG. 9 is a top front perspective view of the basin with the cover removed for clarity;

FIG. 10 illustrates a top front perspective view of another preferred embodiment of a recirculating pet fountain and pet food holder constructed in accordance with the present invention;

FIG. 11 is a top perspective view of the cover of the fountain of FIG. 10 illustrating a pet food holder that is a grower defined by a grower pocket integrally formed in the cover;

FIG. 12 is a bottom perspective view of the fountain cover and integral grower of FIG. 11;

FIG. 13 is a side elevation view of the cover and integral grower;

FIG. 14 is a top perspective view of the basin of the fountain with the cover removed; and

FIG. 15 illustrates a preferred but exemplary embodiment of an insert that can be pre-packaged as a unit that is removably inserted into a grower pocket of a pet food holder of a recirculating pet fountain and pet food holder constructed in accordance with the present invention.

Before explaining embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

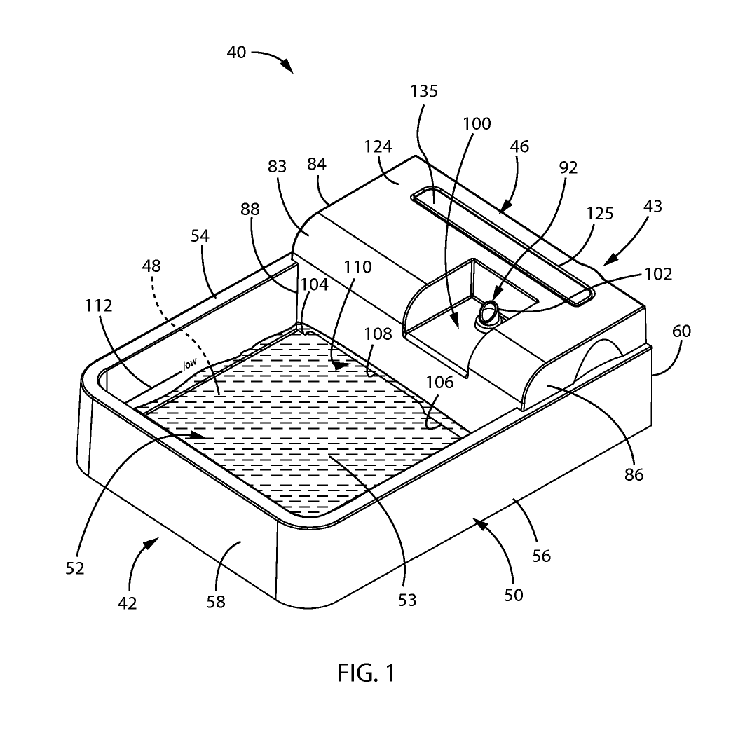

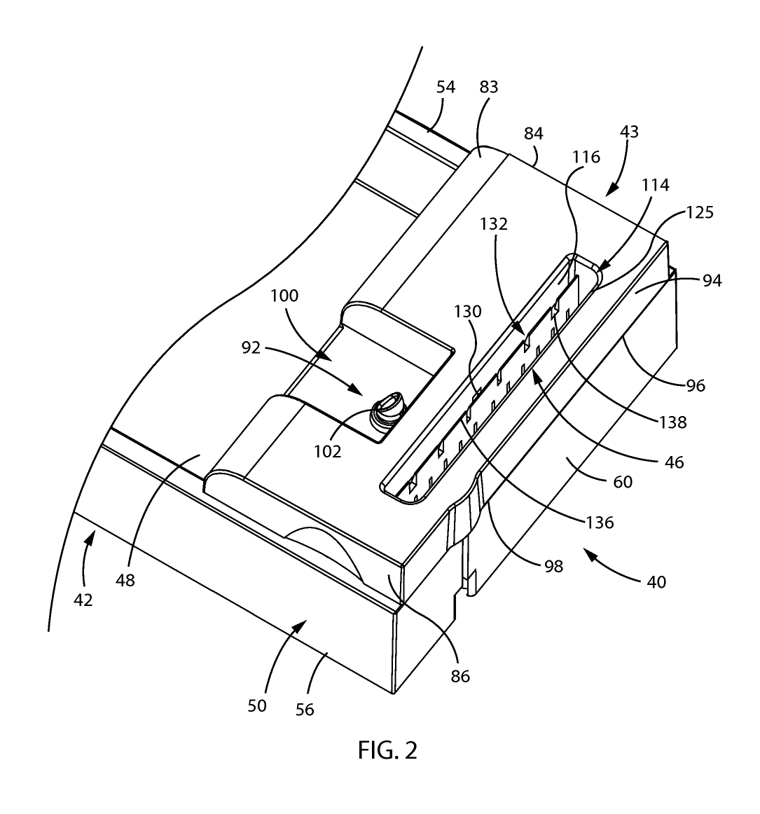

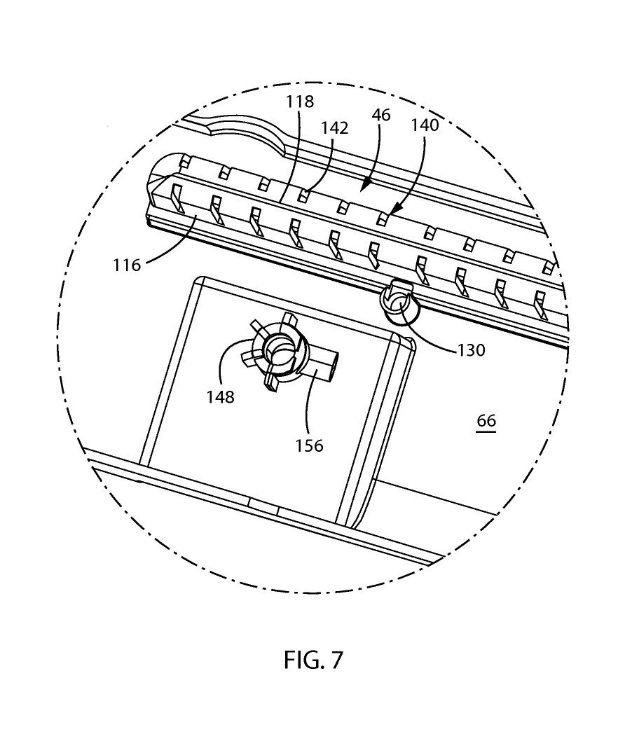

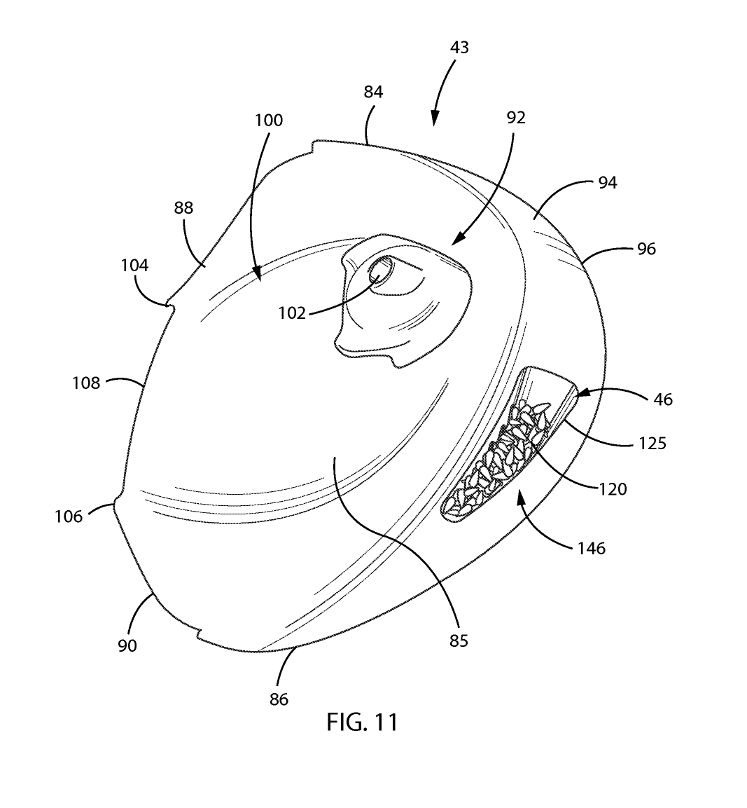

FIGS. 1-14 illustrate one or more preferred embodiments of a recirculating pet fountain 40 constructed in accordance with the present invention having a water-holding fountain basin 42, a pump 44, and a pet food holder 46. Additionally, the recirculating pet fountain 40 can have a fountain cover 43 that can be seated or connected to the basin 42. The basin 42 and cover 43 constructed in accordance with the present invention are preferably made of a dishwasher safe material that can be a plastic, such as polypropylene, polyethylene, or the like, a metal, such as a stainless steel, or another suitable material, such as a ceramic material.

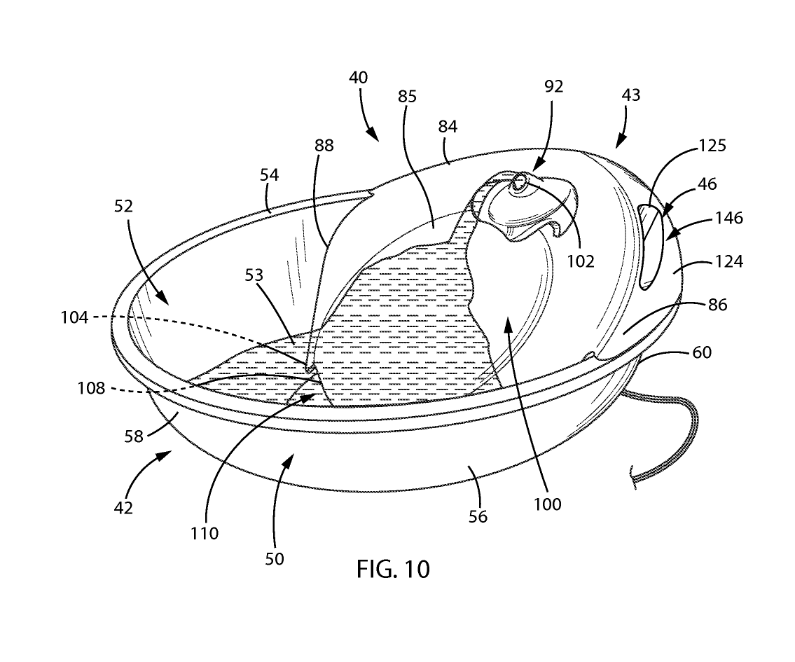

Looking specifically to FIGS. 1, 9 and 14, the basin 42 has a bottom 48 and a sidewall 50 extending generally upwardly from the bottom 48 that defines a basin 42 configured to hold water 53 and form a base upon which the fountain 40 rests. The sidewall 50 can extend endlessly as shown in the illustrated embodiments. Within the sidewall 50 of the basin 42 is an open drinking bowl 52 (FIG. 1) in which water 53 is retained in a manner that permits a pet, such as a cat, dog or another animal, to drink therefrom. The underside of the bottom 48 of the basin 42 can be substantially flat so that it can rest on a flat surface, such as the floor, a table, or the like, helping to provide a stable base for the fountain 40. The basin 42 may also be constructed to have a plurality of different elevations, wherein a sump area 55 of the basin 42 has a lower elevation than the open drinking bowl 52. This encourages water 53 to flow via gravity from the open drinking bowl 52 into the sump area 55 while preventing backflow of the water 53 from the sump area 55 to the open drinking bowl 52. As shown, the basin 42 may be of a generally elongated design with a pair of spaced apart sides 54, 56, e.g., sidewalls 54, 56, and a pair of spaced apart ends 58, 60, e.g., endwalls 58, 60. For instance, the basin 42 can be generally rectangular as shown in FIGS. 1-9, or the basin can be oblong in shape, such as the generally oval basin shown in FIGS. 10-14. However, any number of different shapes of basins 42 may be used, which would produce correspondingly differently shaped recirculating pet fountains 40.

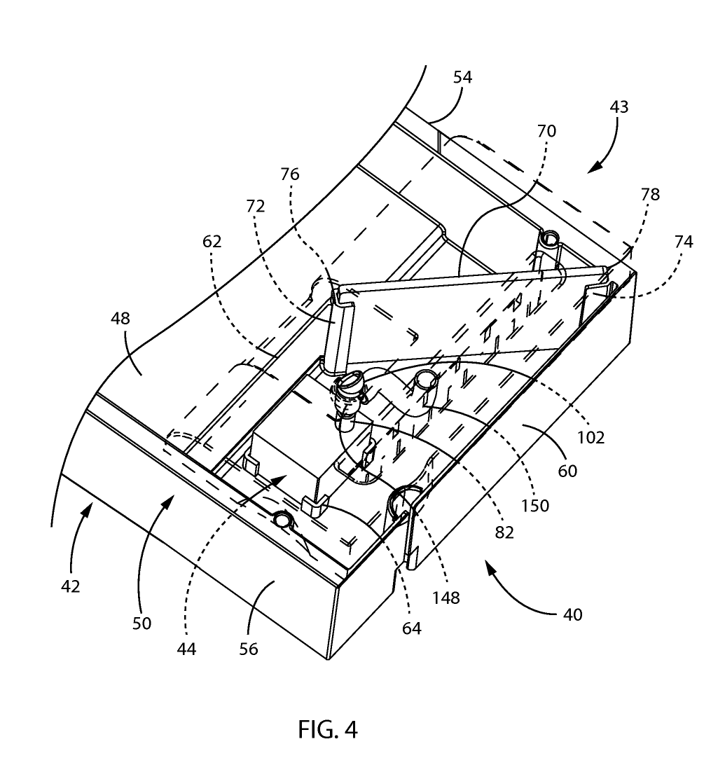

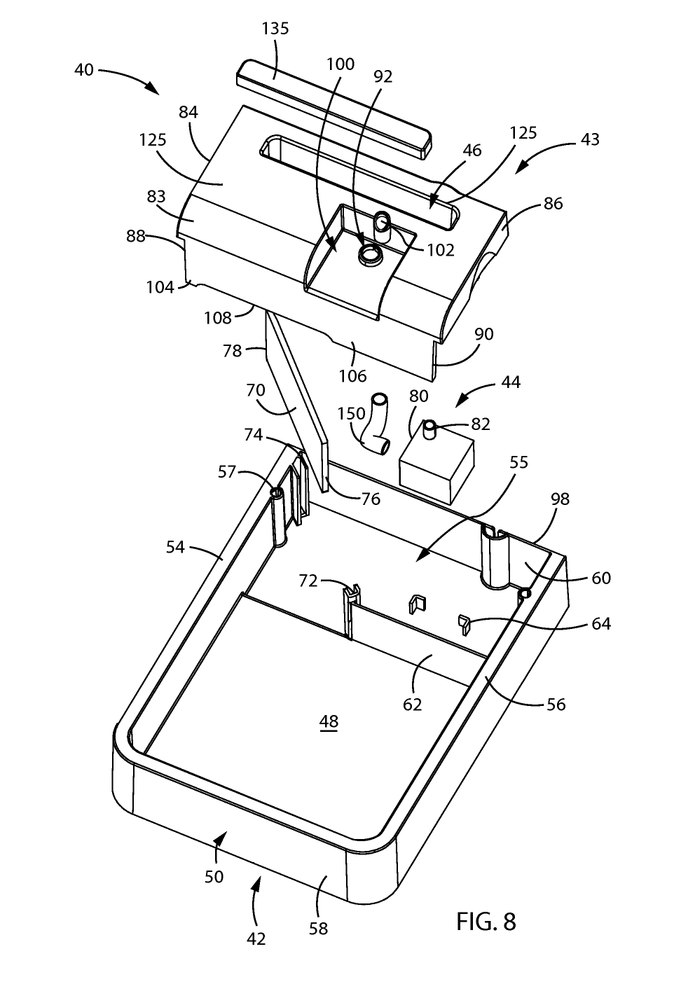

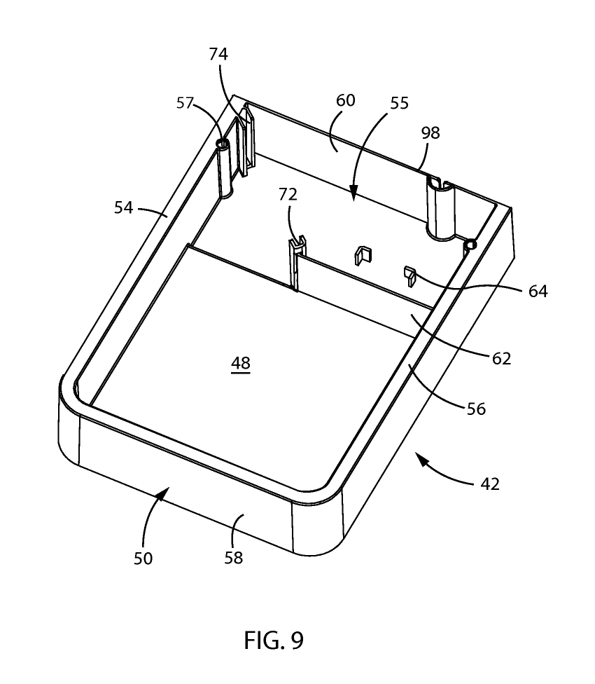

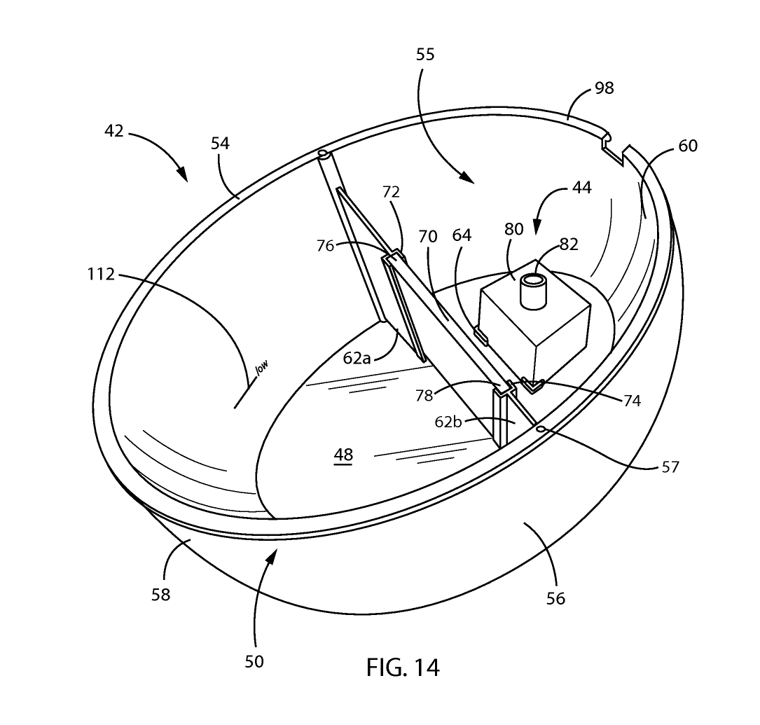

Looking to FIGS. 8 and 9 the basin 42 can additionally have a partition 62 that extends from one side 54 of the basin sidewall 50 towards the opposite side 56 of the sidewall 50. If desired, two partition 62a, 62b may extend from both sides 54, 56 towards the center of the basin 42 as shown in FIG. 14. The partition 62 may be used to separate the open drinking bowl 52 from the remainder of the basin 42. As shown, the partition 62 may be used to isolate the open drinking bowl 52 from a sump area 55 in which the pump 44 is housed. In operation, the pump 44 is then located opposite the partition 62 from the open drinking bowl 52. As best shown in FIGS. 4 and 8, the pump 44 preferably is removably received in the sump area 55. The sump area 55 may have a pump seat 64 formed in the bottom 48 of the basin 42, in which the pump 44 may rest or otherwise be secured. Additionally, the basin 42 may have a cover locator receiver 57 in which a cover locator 68 may be received. As illustrated, the cover locator receiver 57 is located along the basin sidewall 50, but the cover locator receiver 57 can be located elsewhere, for instance, along the partition 62.

Also, the recirculating pet fountain 40 may include a filter element 70 that can be a replaceable water filter as known in the art. The filter element 70 may be accepted by two grooves or channels 72, 74 configured to slidably receive and releasably retain the side edges 76, 78 of the filter element 70. For instance, the partition 62 may have the first groove or channel 72 opposite the second groove or channel 74 located in the basin sidewall 50 as shown in FIGS. 8 and 9. Alternatively, where there are two partitions 62a, 62b, the first partition 62a may have the first groove or channel 72 and the second partition 62b may have a second groove or channel 74. In either embodiment, the grooves or channels 72, 74 are located directly across from one another. The combination of the filter element 70 and the partition 62 may result in a sump area 55 that is located in a portion of the the basin 42 opposite the open drinking bowl 52. In such a configuration, the pump 44 may be seated in a pump seat 64 located within the sump area 55. As a result, all water 53 that is recirculated through the open drinking bowl 52 of the basin 42 during fountain operation will first travel through the filter element 70 before entering the pump 44. This will help ensure that the water 53 flowing throughout the recirculating pet fountain 40 is clean.

The pump 44 is in water-flow communication with the basin 42. As shown, the pump 44 is seated on the bottom 48 of the basin 42, although it could be located elsewhere. The pump 44 has an intake 80 through which water 53 is drawn from the sump area 55 of the basin 42 into the pump 44 and out through a discharge outlet 82. The discharge outlet 82 is in fluid communication with the cover 43, such that water 53 is pumped from the basin 42 to the cover 43. A portion of the water 53 expelled from the discharge outlet 82 may also be distributed to the pet food holder 46.

The pump 44 can be a submersible pump, such as a submersible magnetic impeller driven aquarium pump that can be directly removably mounted to the basin bottom 48 by one or more elastomeric suction cups (not shown) or can be part of a pump module (not shown) having a housing with a discharge outlet nipple or tube in fluid flow communication with the pump discharge outlet nipple that also telescopically engages the lift tube 148 of the fountain cover 43. Such a pump 44 is connected to a source of electricity, such as by an electrical cord that is either connected by a multi-pronged plug to a source of utility alternating current electricity at a voltage greater than 100 volts AC or which is stepped down to a lesser voltage using a transformer or the like to a voltage that can be direct current voltage that is less than 25 volts that can be 12 volts or less.

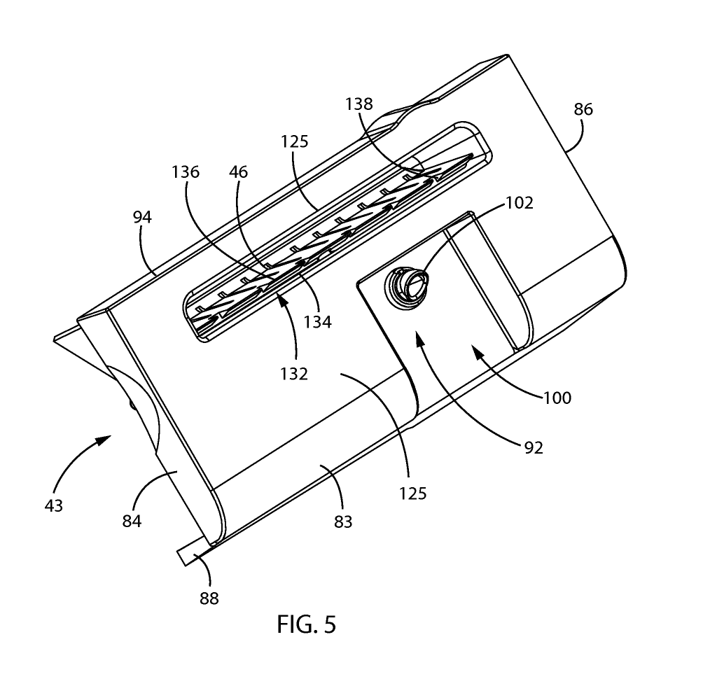

Additionally, the recirculation pet fountain 40 may include a cover 43. The cover 43 may be in a variety of designs, for instance, in a generally rectangular design with a curved front edge 83 as shown in FIG. 5 or a generally rounded design with a sloped front face 85 as shown in FIG. 10. The interaction of the cover 43 with the basin 42 is best illustrated in FIGS. 1 and 10. The cover 43 has a pair of sidewalls 84, 86 that rest on the spaced apart sides 54, 56 of the basin 42. Additionally, the cover 43 may have a pair of side edges 88, 90 that extend downwardly from the cover sidewalls 84, 86. These side edges 88, 90 can abut the spaced apart sides 54, 56 of the basin 42. As a result, side-to-side movement of the cover 43 towards or away from either spaced apart side 54, 56 of the basin 42 can be minimized once the cover 43 is mounted to the basin 42. It is preferred that the cover 43 is removably mounted to the basin 42. When the cover 43 is mounted to the basin 42, it may enclose a portion of the basin 42 wherein the pump 44 is enclosed, creating an enclosed sump area 55 on one side of the basin 42 opposite the open drinking bowl 52 on the other side of the basin 42. Additionally, a water outlet 92 through which water can be redistributed will extend through the underside surface 66 of the cover 43. In a preferred embodiment, the water outlet 92 will be located substantially vertically above the pump discharge outlet 82.

The cover 43 has an underside surface 66 facing generally toward the basin bottom 48 from which at least one cover locator 68 can outwardly extend that is accepted by a cover locator receiver 57 located in the basin 42. When the cover locator 68 is inserted into the receiver 57, front-and-back movement of the cover 43 relative to the basin 42 toward either of the spaced apart ends 58, 60 of the basin 42 is prevented. As should be readily apparent to one skilled in the art, the cover 43 can be constructed without any cover locator 68 such that the cover 43 can be configured without a locator 68.

The cover 43 seats on the basin 42 in a manner that not only can locate the cover 43 relative to the basin 42 and pump 44 during assembly, it also helps releasably yet securely retains the cover 43 on the basin 42 in a manner that can help prevent the cover 43 from moving relative to the basin 42 after it has been mounted on the basin 42. The cover 43 includes a rear wall 94 having a bottom edge 96 that rests on a top edge 98 of the basin sidewall 50. The cover 43 also includes a spillway 100 that allows water 53 to be returned to the basin 42 from the open drinking bowl 52 after it has flowed into the sump area 55 and through the pump 44. The spillway 100 may be substantially flat and have a flow directing orifice 102, such as a spout, that projects water 53 away from the cover 43 and into the basin 42 as shown in FIGS. 1-4. The flow directing orifice 102 should be removable and interchangeable with a number of different shapes being compatible with the same cover 43 that vary based on the desired flow of the water 53 to the basin 42. This would allow the flow directing orifice 102 to be removed for cleaning or washing. Alternatively, the spillway 100 may extend downwardly from the rear wall 94 of the cover 43 toward the basin bottom 48. This would allow gravity to help return the water 53 to the basin 42. Additionally, a combination of a downwardly extending spillway 100 and a flow directing orifice 102 may be used as shown in FIG. 10.

The cover 43 may rest on the bottom 48 of the basin 42 on a pair of feet 104, 106 spaced apart to offset a bottom spillway edge 108 from the basin bottom 48 defining an intake 110 through which water 53 flows from the open drinking bowl 52 into the sump area 55 during recirculating fountain operation. The intake 110 defining bottom edge 108 of the cover 43 is disposed adjacent the basin bottom 48 below a minimum water line 112 of water 53 needed in the basin 42 for the fountain 40 to properly work.

The recirculating pet fountain 40 also features a pet food holder 46. The pet food holder 46 includes a recess 114 that is defined by a sidewall 116 that extends downwardly to a bottom 118 defining a food holding receptacle, preferably a pocket, in which a pet food providing material 120 can be removably deposited. Water 53 from the basin 42 is introduced to the pet food holder 46 from the pump 44. Preferably, the pet food providing material 120 inserted into the pet food holder 46 can grow with help of the water 53 provided by the pump 44 that wets the pet food providing material 120 during recirculating fountain operation. The recess 114 of the pet food holder 46 advantageously is large enough and versatile enough to permit a plurality of different types of pet food providing material 120 to be received in it that respond when wetted by water to produce pet edible food that can be food grown when watered.

The pet food providing material 120 can be used with a growing medium 122 that can be formulated such as with a fertilizer or the like to provide added nutrients to further facilitate food growth where the pet food providing material 120 can be grown. Such a growing medium 122 can be configured to not only encourage growth of plant-based pet food providing material 120, but the growing medium can be formulated or treated in a manner that treats the water in the fountain during recirculating fountain operation. In addition, roots from plant-based pet food providing material 120, whether grown alone in the pet food holder 46 or in combination with growing medium 122 preferably also helps filter water flowing through the pet food holder 46 during recirculating pet fountain operation.

The pet food holder 46 may be located amongst the recirculating pet fountain 40. For instance, the pet food holder 46 may be formed as a separate unit which attaches to part of the fountain 40, such as the cover 43 or the basin 42, or can be integrally formed with or in part of the fountain 40, such as by being integrally formed in the cover 43 or the basin 42. Where formed as a separate unit, the pet food holder 46 can be a standalone component that is added, e.g., retrofitted, to a recirculating pet fountain 40 lacking any such pet food holder 46.

As shown in FIGS. 1-14, where the recirculating pet fountain 40 includes a cover 43, the pet food holder 46 is carried by the cover 43 preferably by being located in or on the cover 43. For instance, the pet food holder 46 may be formed or molded into an outer surface 124 of the cover 43 when the cover 43 is manufactured. In one formed or molded cover 34 shown in FIGS. 1-8, the pet food holder 46 is integrally formed or integrally molded into the cover 34 during molding, e.g. plastic injection molding, of the cover 34. The pet food holder 46 can also be formed or molded into the basin 42 if desired. The pet food holder 46 may also be carried by the basin 42 or cover 43 in a manner where the holder 46 is not integrally formed in or with any part of the basin 42 or cover 43.

The pet food holder 46 can have a number of different size configurations based on the size and dimensions of the recirculating pet fountain 40, the size and dimensions of the inserts 127 that house the food providing material 120, aesthetic appeal, and the like. Each pet food holder 46 will have a top edge 125 that extends down into at least one sidewall 116 that extends toward and can form at least a portion of a bottom 118. A water inlet 130 to the pet food holder 46 is formed of at least one small opening, can be located in a sidewall 116 of the pet food holder 46 through which water 53 at least wets the interior of the holder 46. If desired, the inlet 130 can be formed of multiple openings be located along the sidewall 116 of the pet food holder 46 to increase the amount or flow rate of water 53 introduced into the holder 46 and/or to increase the inlet surface area of such a water flow entrance 130 that can help prevent plugging or disruption of water flow to the holder 46. The use of such a multiple opening inlet 130 can also distribute water along substantially the entire length of the pet food holder 46 enabling pet food providing material 120 received in the holder 46 to be substantially uniformly watered along its entire length and/or width. If desired, water 53 may be distributed over the top edge 125 of the pet food holder 46 in a manner that causes water to flow over the top edge 125 of the holder 46 during recirculating fountain operation. In yet another embodiment, the water may be introduced into the pet food holder 46 directly from the bottom 118 of the holder 46.

In the embodiment shown in FIGS. 1-9, the pet food holder 46 may be of a generally elongate design that can run along substantially the entire width of the recirculating pet fountain 40. To encourage movement of the water 53 along the width of the elongate pet food holder 46, a flow distributing shelf 132 may be utilized. The shelf 132 may consist of a small ridge 134 that extends perpendicularly from the water flow entrance 130 along the length of the pet food holder 46. A series of tabs 136 may extend upwardly from the ridge 134 with small spaces 138 located therebetween. As water 53 flows out of the water flow entrance 130, the tabs 136 will prevent the water 53 from flowing directly down the sidewall 116 of the pet food holder 46. Rather, the tabs 136 will encourage lateral movement of the water 53 along the length of the shelf 132. The sidewall 116 extends from the ridge 134 in a downward direction opposite the direction of the tabs 136. The spaces 138 located between the tabs 136 allow some of the water 53 to flow downward along the sidewall 116 and into the food providing material 120. This ensures distribution of water 53 along the length of the shelf 132. As a result, water 53 will be distributed to all of the food providing material 120 located along the length of the shelf 132. Other designs of flow distributing shelves may be utilized that allow limited water flow at multiple locations that are spaced apart along the length of the pet food holder 46. For instance, instead using the illustrated tabs, the sidewall 116 may extend past the ridge 134. The sidewall 116 could then have several holes or openings located along the length of the shelf 132. Other shelf configurations could be utilized to ensure a similar effect of allowing some, but not all, of the water 53 to flow at various strategically elected points. This ensures that all the pet food providing material 120 receives sufficient water 53 to encourage growth.

The shelf 132 may also have a cover 135 that serves to cover the pet food holder 46. This can be used when the pet food providing material 120 is a ready-to germinate or ready-to-grow growable pet food received within the pet food holder 46 is not yet ready to be consumed by the pet. In covering the pet food holder 46, the growable pet food can germinate and mature by growing upwardly out of the holder 46 to the point that it produces enough pet edible food to be consumable by the pet.

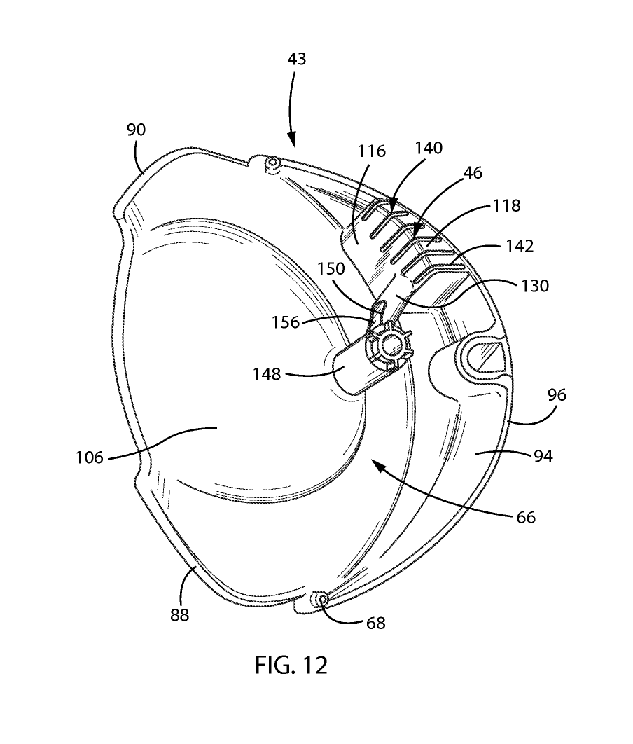

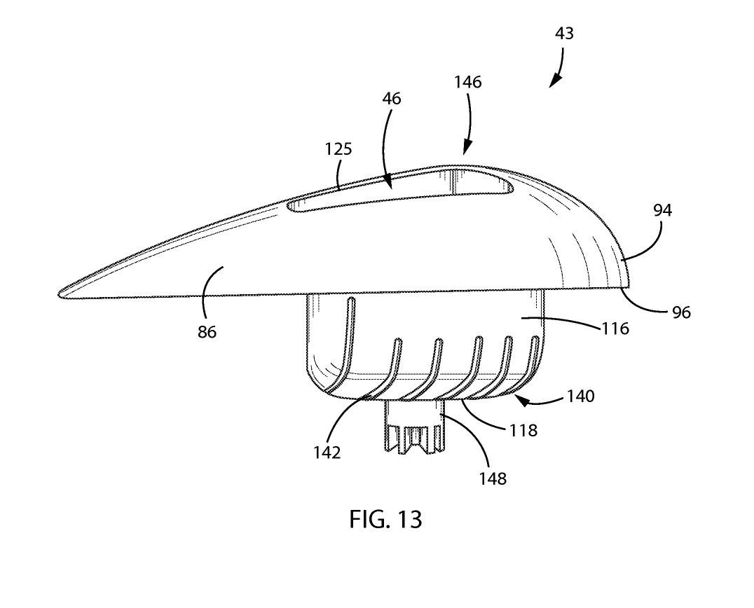

As shown in FIGS. 5-7, the sidewall 116 extends downward to create a pet food holder 46 with a generally rounded bottom 118. However, the bottom 118 could also be formed into a generally rectangular or flat shape as shown in FIGS. 12 and 13. The shape of the pet food holder 46 may vary to better accommodate a variety of different shaped pet food inserts 127.

Regardless of the overall shape of the pet food holder 46, it preferably includes a drain 140 that allows excess water 53 not consumed by growable material in the holder 46 to return to the basin 42. The drain 140 may overly the water 53 in the basin 42 and can be spaced above the water 53 such that the excess water 53 will return to the basin 42 if not consumed by the pet food providing material 120. Preferably, the drain 140 will be located above the sump area 55 such that any excess water 53 will flow directly to the sump area 55 and enter into the pump intake 80 for recirculation. As illustrated, the drain 140 is formed of a plurality of perforations 142 located in the bottom 118 of the pet food holder 46. Other drains may be used, such as a single perforation, overflow, exit tube, bore, and any other drain as known in the art or a combination thereof. The drain 140 may be formed simultaneously with the formation of the cover 43 and pet food holder 46, or it may later be created or installed.

The drain 140 may be located on the bottom 118 of the holder 46, on a sidewall 116 of the holder 46, or even along a top edge 125 of the holder 46. The bottom 118 of the pet food holder 46 may also be sloped as desired to further increase movement of water 53. The pet food holder 46 may even have a sloped ridge bottom (not shown) that will encourage water 53 movement along the length of the holder 46. This is be desirable as it would ensure that all the pet food providing material 120 receives sufficient nutrients for survival. For instance, if the water flow entrance 130 is located at one end of the pet food holder 46, the bottom 118 may be sloped away from the water flow entrance 130 and towards a drain 140 located along the bottom 118 at the lowest elevation of the pet food holder 46. Such a configuration allows water 53 to flow through the pet food holder 46 before it is returned to the basin 42 with the help of gravity. The bottom 118 of the pet food holder 46 may have other configurations to accommodate the desired effect. For instance, if the drain 140 is located in the center of the holder 46, the bottom 118 should be sloped from all sidewalls 116 toward the drain 140 to ensure that no water 53 is left to sit in the holder 46.

In an alternative embodiment, the pet food holder 46 may be a smaller pocket 146 as shown in FIGS. 10-14. As illustrated, the pocket 146 is formed of a sidewall 116, with the sidewall 116 extending into a bottom 118. In this embodiment, the sidewall 116 extends substantially vertically downward into the cover 43. The bottom 118 of the pocket may be sloped slightly to encourage water 53 movement. In such configurations, several perforations 142 may be located along the bottom 118 of the pocket 146 to serve as a drain 140. Alternatively, a single drain 140 may be located where the pocket 146 has the lowest elevation. This helps to ensures that all of the pet food providing material 120 receives water 53. This configuration allows water 53 to be pumped directly into the sidewall 116, after which the water 53 will flow down the sidewall 116 and into the pocket 146. Water 53 will then flow along the length of the sloped bottom 118 before returning to the basin 42 through the drain 140. As such, the food providing material 120 in the pet food holder 46 will continuously be exposed to water 53.

Water 53 may be delivered to the pet food holder 46 in a number of ways. For instance, the water discharge outlet 82 of the pump 44 may provide water 53 directly to the pet food holder 46. Alternatively, the pet food holder 46 may be located downstream from the pump water discharge outlet 82 such that gravity distributes water 53 to the pet food holder 46. This would allow water 53 distribution to the pet food holder 46 without the use of a lateral conduit or tube to deliver the water.

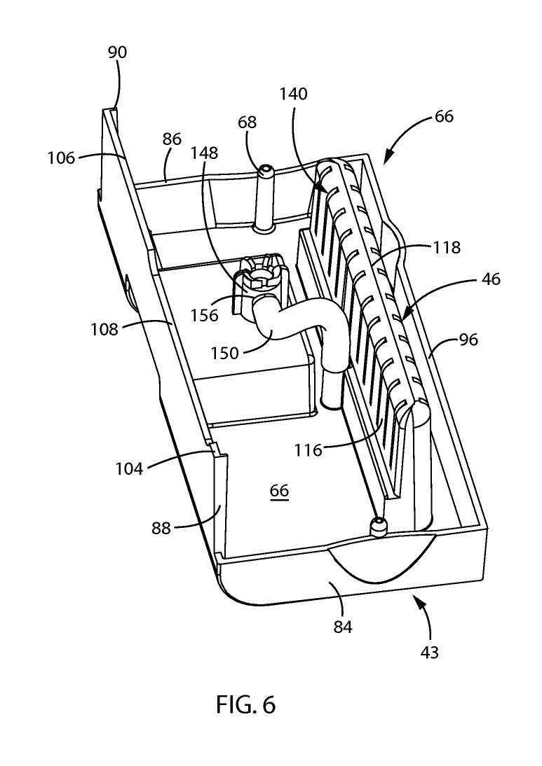

In the illustrated embodiments, the flow of water 53 from the pump discharge outlet 82 may be split such that a portion of water 53 is directed toward the pet food holder 46 and a portion of the water 53 is directed toward the cover 43 as can best be seen in FIGS. 6, 7 and 12. The water 53 directed toward the cover 43 would then be returned to the open drinking bowl 52 and would then be recirculated amongst the basin 42. For instance, a lift tube 148 that is generally vertically downwardly extending from the cover 43 may be connected to the pump discharge outlet 82. The lift tube 148 could be formed integrally with the cover 43 or it could be separately manufactured and later connected, attached, or otherwise associated with the cover 43. In addition to recirculating water 53 to the basin 42, the lift tube 148 may serve an additional purpose as it may help guide cover 43 placement when aligned with the pump 44. This will be appreciated where the pump 44 is located in the pump seat 64 and the pump discharge outlet 82 extends in a vertical direction. When the lift tube 148 is properly aligned with the pump discharge outlet 82, the remaining portions of the cover 43 should align with the basin 42. Preferably, the lift tube 148 would be telescopically received by the pump discharge outlet 82. Water 53 exiting the pump discharge outlet 82 and moving through the lift tube 148 would then be discharged through the water outlet 92 of the cover 43. As illustrated, this could be accomplished using a flow directing orifice 102, such as a spout. Any number of different spouts could be used, or the water 53 could be returned by only the water outlet 92 if the spillway 100 has sufficient slope to allow gravity to return the water 53 to the basin 42.

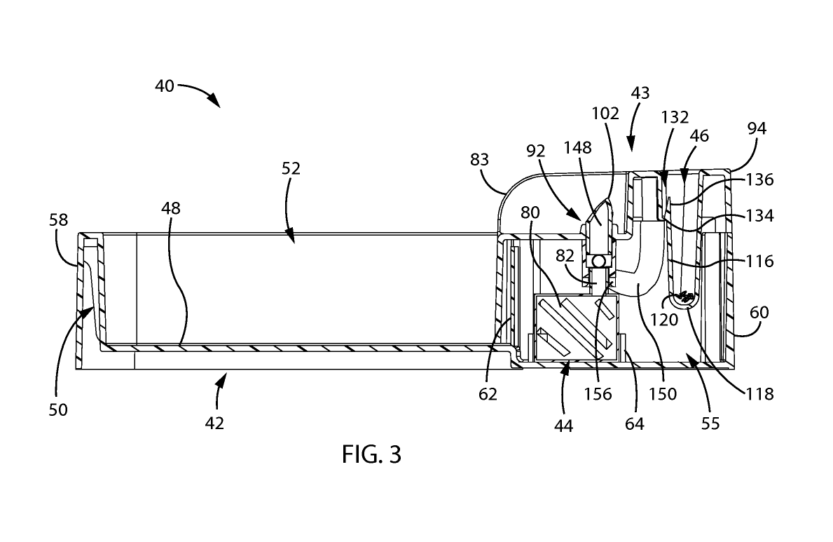

Additionally, a water conveying conduit 150 may be used to deliver water 53 from the pump discharge outlet 82 to the pet food holder 46. The water conveying conduit 150 may be a lateral conduit that extends substantially perpendicular to the lift tube 148 in a horizontal direction, as shown in FIG. 12. or it could extend both in a horizontal and vertical direction as shown in FIGS. 3, 4, and 6. The water conveying conduit 150 can be made of a variety of materials such as a soft, bendable plastic; a hard, rigid plastic; metal; ceramic; or the like. As shown, the water conveying conduit 150 is a tube of a generally cylindrical shape.

The water conveying conduit 150 may connect directly from the pump discharge outlet 82 to the water flow entrance 130 in the pet food holder 46. The water conveying conduit 150 may also extend from the lift tube 148 that delivers water from the pump discharge outlet 82 up to the flow directing orifice 102 above the spillway 100. This could be accomplished by a water conveying conduit 150 that is formed with the lift tube 148, or a water conveying conduit 150 that is later connected to the lift tube 148 by a diverter, connector, nipple, or the like. The water conveying conduit 150 can then be run beneath the underside surface 66 of the cover 43 and into the pet food holder 46. In yet another embodiment, the water conveying conduit 150 could also be formed or molded with the cover 43. Each of the cover 43, the lift tube 148, and the water conveying conduit 150 may be manufactured together or separately and later assembled. For instance, where separately assembled, the lift tube 148 could have a flow-diverter 156 that allows for varied movement of the water to the cover 43 and movement of the water 53 to the pet food holder 46. At least a portion of the water 53 is then diverted from the lift tube 148 to the water conveying conduit 150. As a result, water 53 is delivered to both the pet food holder 46 and to the cover 43. This allows the discharge outlet 82 of the pump 44 to be in water flow communication with both the cover 43 and the pet food holder 46. Once the water 53 reaches the cover 43, it can be returned to the basin 42 by the flow directing orifice 102. Preferably, the lift tube 148 will telescopically register with the discharge outlet 82 of the pump 44 as this will help secure the cover 43 in place.

The pet food holder 46 houses the pet food providing material 120 which comprises a growable pet food 158 that can be grown using water 53. The food providing material 120 can either be inserted directly into the pet food holder 46 or in an insert 127 that is configured to fit within the pet food holder 46. The growable pet food 158 may be a variety of different materials that grow into pet foods known in the art, such as seeds, seedlings sprouts, plants, buds, roots, shoots, and any other hydrophilic edible medium that consume and are nourished primarily by the water 53. Examples of such pet food providing material 120 that is a suitable growable pet food 158 includes wheat, wheat grass, alfalfa, rye, buckwheat, triticale, other types of grasses, legumes, and the other types of grasses, plants, roots, sprouts and the like. Preferably, the growable pet food 158 will be self-replenishing, but if not, new growable pet food 158 can be added as needed. By using a growable pet food 158 that grows over time, the amount of available food will gradually increase. This will allow a pet to enjoy the growable pet food 158 without gorging itself in excessive amounts of food. Once the growable pet food 158 has been eaten, the pet will then have to wait until the food regrows.

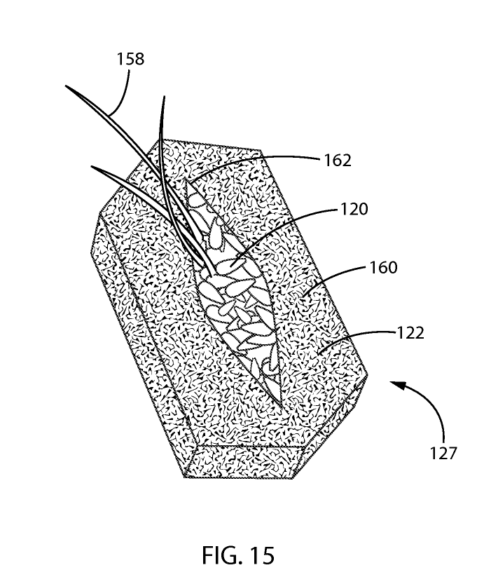

Preferably, the growable pet food 158 can grow without the use of soil. To provide the need nutrients, a growing medium 122 may be used to house the growable pet food 158 as shown in FIG. 15. The growing medium 122 provides added nutrients that further support the growth of the growable pet food 158. For instance, the growing medium 122 may be a porous foam insert 160 that may be inserted into the pet food holder 46 as shown in FIG. 15. The foam insert 160 will then have an opening 162 where the growable pet food 158 may be inserted. The growing medium 122 may come in a variety of inserts 160 sizes and shapes that can be accommodated in the pet food holder 46. The growing medium 122 could even be of a snap-fit configuration in relation to the pet food holder.

In operation, water 53 may be introduced to the basin 42 and the pet food providing material 120 may be introduced to the pet food holder 46. Once the pump 44 is turned on, water will move from the basin 42 and through the filter element 70 into the sump area 55. Water 53 will then enter into the pump intake 80 and out the pump discharge outlet 82. A portion of the water 53 is pumped to the cover 43 where it is returned to the open drinking bowl 52 of the basin 42 using the flow directing orifice 102 for further recirculation. The remaining portion of water 53 that is pumped will be delivered to the pet food holder 46. The water 53 will then wet the pet food providing material 120 before it exits the pet food holder 46 through a drain 140. The water 53 provided would be sufficient to allow the growable pet food 158 located within the pet food providing material 120 to grow. The drain 140 will be located such that the excess water 53 is returned to the basin 42, preferably the sump area 55 of the basin 42. The cycle would then be repeated. As a result, a pet would be able to enjoy both water 53 in the open drinking bowl 52 of the basin 42 and growable pet food 158 in the pet food holder 46.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

1. A recirculating pet fountain comprising:
a water-holding fountain basin having a sidewall;
a pump in water-flow communication with the basin;
a pet food holder, wherein a pet food providing material is received in the pet food holder, and wherein the pump has a discharge outlet from which water from the pump wets the pet food providing material received in the pet food holder; and
a fountain cover in which the pet food holder comprises a pocket formed in the cover.

2. (canceled)

3. (canceled)

4. The pet fountain of claim 1 wherein the pet food providing material comprises a growable pet food received in the pet food holder pocket that grows when wetted by water from the pump.

5. The pet fountain of claim 1 wherein the pet food holder has a drain from which water in the pet food holder pocket drains into the basin.

6. The pet fountain of claim 1 wherein the pet food holder holds a pet food providing material, and wherein the pet food holder overlies water in the basin and is spaced above water in the basin.

7. The pet fountain of claim 6 further comprising a fountain cover that carries the pet food holder.

8. The pet fountain of claim 7 wherein the pet food holder comprises a pocket integrally formed in the fountain cover.

9. The pet fountain of claim 1 further comprising a fountain cover carried by the fountain basin, wherein the pet food holder comprises a pocket formed in an outer surface of the fountain cover in which a pet food providing material is received.

10. The pet fountain of claim 9 wherein the pet food providing material comprises a growable pet food comprised of at least one of seeds, seedlings, sprouts and plants.

11. The pet fountain of claim 10 wherein water recirculated by the pump during fountain operation wets growable pet food received in the pet food holder pocket.

12. The pet fountain of claim 11 further comprising a growing medium received in the pet food holder pocket that supports growth of the growable pet food.

13. The pet fountain of claim 12 wherein the growing medium is comprised of a porous foam insert disposed in the pet food holder pocket in which at least one of seeds and roots of growable pet food are held.

14. The pet fountain of claim 1 wherein the pump has a discharge outlet and the pet food holder receives water discharged from the discharge outlet of the pump during pump operation.

15. The pet fountain of claim 14 further comprising a water-conveying conduit conveying water discharged from the discharge outlet of the pump to the pet food holder.

16. The pet fountain of claim 15 wherein the water-conveying conduit comprises a tube.

17. The pet fountain of claim 14 wherein the pump has a flow of water discharged from the discharge outlet of the pump with one portion of the pump water flow recirculating through the pet fountain and another portion of the pump water flow received by the pet food holder.

18. The pet fountain of claim 17 further comprising a water-conveying conduit conveying water discharged from the discharge outlet of the pump to the pet food holder.

19. The pet fountain of claim 1 further comprising a fountain cover, the pump comprising a discharge outlet in water flow communication with both (a) the fountain cover, and (b) the pet food holder.

20. The pet fountain of claim 19 wherein the pet food holder is integrally molded of part of the fountain cover.

21. The pet fountain of claim 19 wherein the fountain cover receives water from the pump through a lift tube that comprises a flow-diverter that diverts water pumped through the lift tube toward the cover to the pet food holder.

22. The pet fountain of claim 21 wherein the pet food holder is carried by one of the fountain basin and the fountain cover.

23. The pet fountain of claim 21 wherein the fountain cover has an integrally formed lift tube that telescopically registers with the discharge outlet of the pump.

24. The pet fountain of claim 23 wherein the pet food holder is integrally formed in one of the fountain basin and the fountain cover.

25. The pet fountain of claim 21 wherein the flow-diverter comprises an elongate tube having one end connected to the lift tube and an opposite end connected to the pet food holder.

26. The pet fountain of claim 25 wherein the pet food holder carried by one of the fountain cover and fountain basin.

27. A recirculating pet fountain comprising:
a water-holding fountain basin;
a fountain cover carried by the basin; and
a pump having an intake in water-flow communication with the fountain basin and a discharge outlet in water-flow communication with the fountain cover; and
wherein one of the fountain basin and fountain cover carries a pet food holder in water-flow communication with the pump.

28. The pet fountain of claim 27 wherein the pump has a flow of water discharged from the discharge outlet of the pump to the fountain cover during pump operation with one portion of the pump water flow recirculating from the fountain cover into the fountain basin and another portion of the pump water flow delivered to the pet food holder.

29. The pet fountain of claim 28 wherein the pet food holder comprises a drain through which water delivered to the pet food holder is returned to water being recirculated through the fountain by the pump during recirculating fountain operation.

30. The pet fountain of claim 29 wherein the pet food holder comprises grower pocket integrally formed in one of the fountain cover and the fountain basin that receives one of a plurality of seeds, seedlings, sprouts and plants nourished by water delivered by the pump to the pet food holder during recirculating fountain operation with excess water delivered to the pet food holder returned by the drain to the fountain basin.

31. The pet fountain of claim 27 wherein the pump is coupled to the fountain cover by a lift tube and comprising a flow-diverting conduit in water-flow communication with the pump and the pet food holder.

32. The pet fountain of claim 31 wherein the flow-diverting conduit extends from the lift tube to the pet food holder.

33. A recirculating pet fountain comprising:
a water-holding fountain basin;
a fountain cover carried by the basin having a pet food holder comprising an integrally formed grower pocket formed in the fountain cover having an opening formed in an outer surface of the fountain cover; and
a pump having an intake in water-flow communication with the fountain basin and a discharge outlet in water-flow communication with the fountain cover; the pump recirculating water from the cover to the basin while delivering water to the grower pocket of the pet food holder enabling at least one of seeds, seedlings, sprouts and plants to consume water delivered to the grower pocket.

34. The pet fountain of claim 33 wherein the grow pocket comprises a perforate drain through which excess water in the grower pocket flows into the basin.
